(19) United States
(12) Patent Application Publication
(10) Pub. No.: US 2026/0350131 A1
(43) Pub. Date: Nov. 5, 2026

(54) RICH ENGAGEMENT RESOURCE ACTIVATION VIA CROSS-DOMAIN DATA AGGREGATION AND SENTIMENT ANALYSIS

(71) Applicant: Sony Interactive Entertainment LLC, San Mateo, CA (US)

(72) Inventors: Paul John Walsh, Kirkland, WA (US); Matthew Smith, Buena Vista, CO (US); David Gardner, Georgetown, TX (US)

(21) Appl. No.: 19/196,337

(22) Filed: May 1, 2025

(51) Int. Cl. G06F 21/32

(52) U.S. Cl. CPC G06F 21/32

(57) ABSTRACT

A computer-implemented method for activating rich engagement resources is described. The method includes receiving user data including media consumption data, biometric data, commerce behavior data, social data, or a combination thereof, processing the user data to generate one or more data signals comprising media signals, biometric signals, commerce signals, social signals, or a combination thereof, processing the one or more data signals using a classifier to generate a classification of the type of user, where the type of user is associated with a particular level of sentiment of the user towards one or more particular subjects, and outputting the classification of the type of user.

### BACKGROUND

The exponential growth of data generated from various sources, including user interactions, social media, and third-party providers, presents both opportunities and challenges for enterprises. This data offers valuable insights into user behavior and preferences, enabling enterprise systems to tailor offerings to meet specific needs and interests of users. By leveraging this data, enterprises can foster stronger relationships with their customers and drive loyalty. Delivering relevant and timely content not only enhances user satisfaction but also improves engagement metrics.

However, the large volume and diversity of data can create significant difficulties in processing and analysis. The computational resources required to handle such abundant data are substantial, making the process both expensive and inefficient. Without efficient processing capabilities, enterprise systems risk delivering outdated or irrelevant content, which can negatively impact user experience and engagement.

### SUMMARY

This specification describes a rich engagement resource activation system implemented as computer programs on one or more computers in one or more locations for activating rich engagement resources by using user feature vectors generated from heterogeneous first-party and third-party data available to an enterprise. In addition, the system utilizes real-time contextual data, such as location, associated with users and data indicating an external real-time context of the physical environment surrounding the users to enable an enterprise system to deliver personalized and contextually relevant engagement resources to users. By integrating diverse data sources and real-time contextual information, the rich engagement resource activation system can dynamically select and present rich engagement resources that align with user preferences and situational contexts. This approach enhances user engagement and satisfaction by providing timely and relevant content.

In general, one innovative aspect of the subject matter described in this specification can be embodied in methods for activating rich engagement resources. The method includes determining a plurality of users whose user feature vectors match a target tag; determining an external real-time context related to the target tag; determining, among the plurality of users, one or more users whose real-time contextual data matches the external real-time context; determining that one or more engagement resources are available for the external real-time context and the target tag; and in response to determining that the user feature vectors of the plurality of users match the target tag, that the external real-time context is related to the target tag, that the real-time contextual data of the one or more users matches the external real-time context, and that one or more engagement resources are available for the one or more users given the external real-time context and the target tag, activating rich engagement resources for the one or more users in the external real-time context.

In some implementations, the method includes transmitting one or more rich engagement resources to one or more user devices of the one or more users.

In some implementations, determining that the user feature vectors match the target tag includes: determining, for each of the user feature vectors, a similarity between the user feature vectors and feature vectors representing the target tag, and determining that the similarity exceeds a threshold level of similarity.

In some implementations, the rich engagement resources include one or more of: music streaming content, movie streaming content, news streaming content, interactive music playlists, live streaming of events, gaming content, in-game rewards, interactive advertisements, video ads, virtual reality experiences, augmented reality experiences, personalized video messages, e-books, audiobooks, podcasts, webinars, online courses, interactive quizzes, social media interactions, mobile app notifications, multimedia presentations, personalized offers, discount coupons, or personalized merchandise offers.

In some implementations, the target tag represents a user interest or preference.

In some implementations, the method further includes: receiving raw data from a data repository, wherein the raw data comprises first-party media engagement data, first-party other data, and third-party data.

In some implementations, the method further includes generating user feature vectors from the raw data. The generation of user feature vectors includes: pre-processing the raw data to address missing values, normalize numerical features, and encode categorical variables, applying dimensionality reduction techniques to the pre-processed data to retain features having variance exceeding a threshold, and transforming, using a machine learning model, the pre-processed and reduced-dimensionality data into user feature vectors, wherein each user feature vector is a numerical representation of characteristics and preferences of the respective user.

In some implementations, the real-time contextual data comprises location data, and determining that the real-time contextual data matches the external real-time context comprises comparing the location data with a plurality of event locations.

In some implementations, the real-time contextual data includes activity data from user devices, and wherein determining that the real-time contextual data matches the external real-time context comprises analyzing the activity data to identify user activities in the external real-time context.

In some implementations, the user devices include at least one of a mobile device, an infotainment system of a vehicle, a wearable device, a gaming console, a smart TV, a laptop or a desktop computer.

Another innovative aspect of the subject matter described in this specification can be embodied in methods adaptively tailoring rich engagement resources. The method includes collecting engagement feedback on one or more rich engagement resources; processing the engagement feedback to generate feedback data; updating a knowledge graph based on the feedback data, wherein the knowledge graph is a dynamic representation of relationships between one or more of users, rich engagement resources, locations, or contextual factors; refining user feature vectors stored in a user feature vector database based on the feedback data and the updated knowledge graph; determining one or more target users based on the refined user feature vectors and a target tag; selecting one or more rich engagement resources based on the user feature vectors of the one or more target users and the external real-time context; and transmitting the one or more selected rich engagement resources to one or more user devices of the one or more target users in the external real-time context.

In some implementations, the engagement feedback includes one or more of clicks, shares, likes, skips, dismissals, purchases, or interaction duration with the activated rich engagement resources.

In some implementations, the knowledge graph is adaptively updated to strengthen or weaken relationships between users and rich engagement resources based on positive or negative engagement feedback.

In some implementations, determining the one or more target users based on the refined user feature vectors and a target tag includes identifying a plurality of users whose user feature vectors, based on the refinement, match a target tag; determining an external real-time context relevant to the target tag; and determining, among the plurality of users, one or more target users whose real-time contextual data matches the external real-time context.

In some implementations, identifying the plurality of users whose user feature vectors, based on the refinement, match the target tag includes calculating, for each user feature vector, a similarity score between the user feature vector and the feature vector representing the target tag; and determining that the similarity score exceeds a predefined threshold.

In some implementations, the target tag represents a user interest or preference.

In some implementations, the real-time contextual data includes location data, and determining that the real-time contextual data matches the external real-time context comprises comparing the location data with a plurality of event locations.

In some implementations, the real-time contextual data includes activity data from user devices, and wherein determining that the real-time contextual data matches the external real-time context includes analyzing the activity data to identify user activities in the external real-time context.

In some implementations, selecting one or more rich engagement resources based on the user feature vectors of the one or more target users and the external real-time context includes (i) updating a probability distribution of a plurality of rich engagement resources (for example, based on the feedback data and the updated knowledge graph), in which each value in the distribution represents a probability of success of each of the plurality of rich engagement resources, and (ii) selecting the one or more rich engagement resources having the highest probabilities of success.

In some implementations, the one or more rich engagement resources include one or more of: music streaming content, movie streaming content, news streaming content, interactive music playlists, live streaming of events, gaming content, in-game rewards, interactive advertisements, video ads, virtual reality experiences, augmented reality experiences, personalized video messages, e-books, audiobooks, podcasts, webinars, online courses, interactive quizzes, social media interactions, mobile app notifications, multimedia presentations, personalized offers, discount coupons, or personalized merchandise offers.

In some implementations, the one or more user devices comprise at least one of a mobile device, an infotainment system of a vehicle, a wearable device, a gaming console, a smart TV, a laptop or a desktop computer.

In some implementations, the method includes using a real-time context correlation engine to adjust the selection of the one or more rich engagement resources based on a correlation between user real-time contextual data and data indicating an external real-time context in a physical environment surrounding the one or more target users.

Another innovative aspect of the subject matter described in this specification can be embodied in methods for determining a type of user. The method includes receiving user data comprising media consumption data, biometric data, commerce behavior data, social data, or a combination thereof; processing the user data to generate one or more data signals comprising media signals, biometric signals, commerce signals, social signals, or a combination thereof; processing the one or more data signals using a classifier to generate a classification of the type of user, where the type of user is associated with a particular level of sentiment of the user towards one or more particular subjects; and outputting the classification of the type of user.

In some implementations, the one or more particular subjects comprise one or more of an entity, an object, an event, a time, a location, or content.

In some implementations, the type of user comprises an average user, a detracting user, an enthusiast user, and a super-enthusiast user.

In some implementations, the media consumption data comprises a media viewing history of the user, media interaction history of the user, or both

In some implementations, the biometric data comprises data associated with a biometric device of the user, where the biometric device measures a heart rate of the user.

In some implementations, the biometric data further comprises facial recognition data, voice recognition data, or both.

In some implementations, the commerce behavior data comprises recent purchase data of the user

In some implementations, the social data comprises activity data for the user associated with a social media website.

In some implementations, the classifier is a multi-class classifier neural network. The classifier is a rule-based classifier.

In some implementations, processing the one or more data signals using the classifier to generate a classification of the type of user includes generating, by the classifier, a respective probability value of each type of user by processing the one or more data signals; and classifying the type of user based on a threshold value associated with the respective probability of each type of user

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The subject matter described in this specification can be implemented in particular embodiments so as to realize one or more of the following advantages.

By activating rich engagement resources of user data, the described techniques significantly improve the personalization capabilities of digital media systems beyond traditional recommendation engines. Specifically, the system can integrate heterogeneous data, including media consumption, biometric, commerce, and social signals, with external real-time contextual information to classify users by sentiment and dynamically activate rich engagement resources tailored to both user preferences and context. For example, the system can identify that a user classified as a “super-enthusiast” is near a relevant event location and automatically deliver high-impact engagement content, such as exclusive livestreams, advertisements, or experiences, through connected user devices. This reduces reliance on static models or generic content distribution techniques, enabling enterprises to engage users with context-aware media.

Such adaptive personalization not only improves user engagement but also optimizes system efficiency. By prioritizing customization opportunities and minimizing irrelevant data processing, the described system decreases the need for constant high-throughput computation across all users and scenarios, allowing computational resources to be allocated more efficiently. As a result, the described system achieves faster response times, reduced latency, and lower overall processing overhead compared to conventional systems that rely on broad-spectrum data analysis or static content delivery.

Additionally, the ability to run engagement activation modules asynchronously allows the system to operate in real-time across diverse platforms, including infotainment systems, user devices, and smart home ecosystems. Through continuous refinement of user profiles based on feature vectors, the system enables a sentiment-driven engagement strategy that efficiently adapts to user behavior and context for personalization.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an exemplary implementation of the engagement resource activation system within an infotainment system of a vehicle.

FIG. 2 is an example engagement resource activation system.

FIG. 3 is a flow diagram of an example process for activating rich engagement resource.

FIG. 4 illustrates an example system for using feedback associated with the activation of rich engagement resources to tailor rich engagement resources.

FIG. 5 is a flow diagram of an example process for using feedback associated with the activation of rich engagement resources to tailor rich engagement resources.

FIG. 6 is another exemplary implementation of the engagement resource activation system.

FIG. 7 is another example engagement resource activation system.

FIG. 8 illustrates an example system for using user data to generate a classification of a type of user.

FIG. 9 is a flow diagram of an example process for using user data to generate a classification of a type of user.

FIG. 10 shows an example of a computing device 1000 and associated accessories that can be employed to execute implementations of the present disclosure.

Like reference numbers and designations in the various drawings indicate like elements.

### DETAILED DESCRIPTION

This specification describes a rich engagement resource activation system implemented as computer programs on one or more computers in one or more locations for activating rich engagement resources by using user feature vectors generated from heterogeneous first-party and third-party data available to an enterprise. In addition, the system utilizes real-time contextual data, such as location, associated with users and data indicating an external real-time context of the physical environment surrounding the users to enable an enterprise system to deliver personalized and contextually relevant engagement resources to users. By integrating diverse data sources and real-time contextual information, the rich engagement resource activation system can dynamically select and present rich engagement resources that align with user preferences and situational contexts. This approach enhances user engagement and satisfaction by providing timely and relevant content.

In addition, the system utilizes user engagement data, such as media consumption data, biometric data, commerce behavior data, and/or social data, to determine a classification of a type of user that is associated with a level of sentiment of the user towards a particular subject, further allowing the system to provide more robust and relevant content for the user. By leveraging these sentiment metrics, the system can personalize user experiences that foster deeper emotional connections and long-term affinity. For example, the system can detect a user's sustained interest in a game and based on the level of the user's sentiment towards the game, recommend tailored experiences to the user.

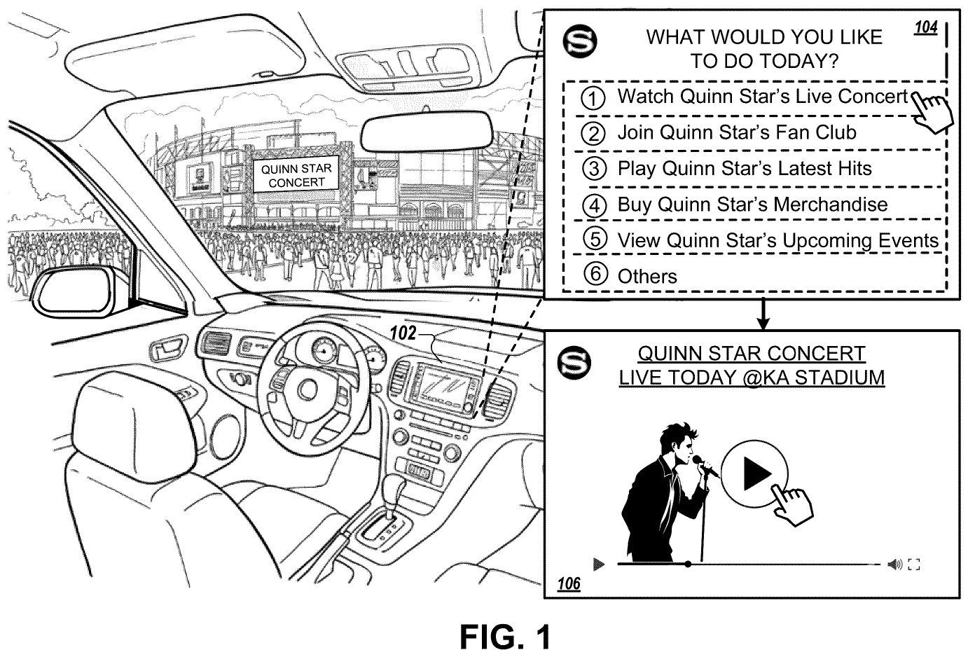

FIG. 1 illustrates an exemplary implementation of the rich engagement resource activation system within a vehicle's infotainment system 102. The rich engagement resource activation system detects that the user is a fan of a particular artist (referred to as “Quinn Star” in this example) and identifies that the user is currently located near a stadium where a Quinn Star concert is taking place. Despite the concert being sold out, the rich engagement resource activation system can present the user with various engagement options related to Quinn Star.

The user interface 104 on the system 102′s screen displays several engagement options for the user: (1) Watch Quinn Star's Live Concert, (2) Join Quinn Star's Fan Club, (3) Play Quinn Star's Latest Hits, (4) Buy Quinn Star's Merchandise, (5) View Quinn Star's Upcoming Events, and (6) Others.

In this example, the user selects the option to “Watch Quinn Star's Live Concert.” The next user interface 106 on the screen of the car's infotainment system shows a live stream of the Quinn Star concert currently taking place at the stadium. This real-time engagement enhances the user's experience by providing immediate access to content that aligns with their interests and current context.

In some implementations, instead of displaying engagement resources on a user interface of a user device (e.g., on the infotainment system's screen), the rich engagement resource activation system may unlock car functionalities or trigger system-to-system interactions based on detected engagement. For example, the system can unlock a free trial subscription to a content service, such as granting temporary access to a premium music streaming platform. As another example, if a user frequently visits a certain type of location, such as a spa or wellness center, the system may temporarily activate premium in-car features like heated seats, ambient lighting, or even massage functions, encouraging continued engagement. Similarly, if the system detects that the user is driving toward a recommended destination, it may proactively adjust navigation settings, optimize climate control, or enable hands-free voice assistance for a seamless experience.

In some implementations, the rich engagement resource activation system interacts with one or more smart devices, making personalized adjustments without requiring direct user input. For example, the rich engagement resource activation system can detect a user's stress level through signals from a smartwatch and can trigger calming music through a smart speaker, or the rich engagement resource activation system can trigger a smart home system to adjust lighting and temperature upon detecting an incoming user. As another example, the rich engagement resource activation system can facilitate system-to-system communication, such as a car coordinating with a parking garage to reserve a spot before arrival. By integrating with multiple devices and environments, the rich engagement resource activation system enhances user experience not just through direct interaction but by intelligently responding to engagement patterns across connected ecosystems.

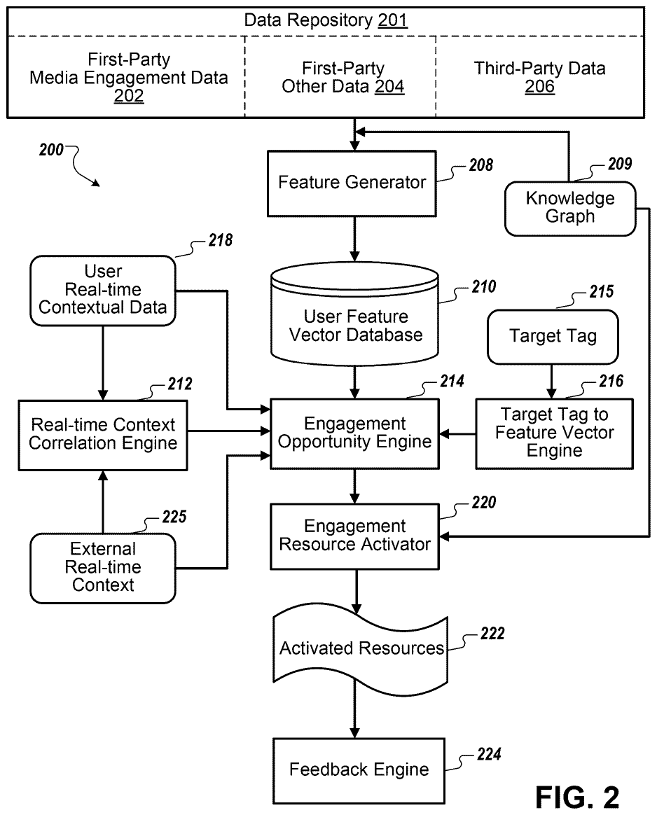

FIG. 2 is an example rich engagement resource activation system 200 configured to activate rich engagement resources. Rich engagement resources refer to interactive and dynamic content that goes beyond static text or images to engage users more effectively. These resources include multimedia elements such as audio, video, animations, and interactive features that allow users to interact directly with the content. Examples of rich engagement resources include music streaming content, movie streaming content, news streaming content, interactive music playlists, live streaming of events, gaming content, in-game rewards, interactive advertisements, video ads, virtual reality experiences, augmented reality experiences, personalized video messages, e-books, audiobooks, podcasts, webinars, online courses, interactive quizzes, social media interactions, mobile app notifications, multimedia presentations, personalized offers, discount coupons, and personalized merchandise offers.

The rich engagement resource activation system 200 is an example of a system implemented as computer programs on one or more computers in one or more locations, in which the systems, components, and techniques described below can be implemented.

The system 200 includes a data repository 201, a feature generating engine (or “feature generator”) 208, a user feature vector database 210, an engagement opportunity engine 214, a real-time context correlation engine 212, a target tag to feature vector engine 216, an engagement resource activating engine (or “engagement resource activator”) 220, and a feedback engine 224. The term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

In some implementations, the feature generator 208, engagement opportunity engine 214, real-time context correlation engine 212, target tag to feature vector engine 216, and engagement resource activator 220 run in parallel and can operate asynchronously. This parallel and asynchronous execution enables the rich engagement resource activation system 200 to process engagement feedback, contextual data, and engagement opportunities in real time, improving responsiveness and personalization.

The data repository 201 stores various types of data, including first-party media engagement data 202, first-party other data 204, and third-party data 206. First-party media engagement data 202 includes information about user interactions with media content, such as games, streaming content, movies, music, and other entertainment activities. The media content may be provided by different businesses or systems within the enterprise, each specializing in various forms of entertainment. For example, one business unit might focus on gaming, another on music, and yet another on movies and streaming services. First-party other data 204 encompasses additional user-related information, such as purchase history, device usage, and other interactions. Third-party data 206 includes data from external sources, such as partner companies, weather information, and other relevant data. The data repository 201 ensures that the system 200 has access to a comprehensive and diverse set of data points to accurately represent user preferences and behaviors.

The feature generator 208 processes the raw data from the data repository 201 to generate user feature vectors, which are numerical representations of data. Each feature vector represents characteristics and preferences of each user, derived from the heterogeneous data available. In some implementations, the system 200 includes a database that stores a knowledge graph 209, which organizes and connects entities such as users, media content, genres, businesses, and external influences (e.g., weather, events, or trends) through relationships. The knowledge graph 209 helps to contextualize user interactions by linking different data points, enabling the system to infer deeper insights about user preferences, content affinities, and engagement patterns. For example, if a user frequently watches a particular movie genre and listens to similar-themed music, the knowledge graph can establish semantic relationships between these activities to enhance engagement resource recommendations. As another example, if a user frequently watches basketball games and follows content related to professional basketball leagues, the knowledge graph 209 can establish relationships between basketball as a sport, specific teams and players, and associated video game categories such as basketball simulation games. If the user also engages with competitive esports content, the system can infer that they might be interested in sports-themed esports games or fantasy sports games. The feature generator 208 may use machine learning models such as neural networks to identify and synthesize relevant user features from the raw data stored in the data repository 201 and the knowledge graph 209. It ensures that the system 200 can create a compact and meaningful representation of each user (e.g., embeddings) that capture each user's preferences and behaviors in a way that can be used for further analysis and engagement resource activation.

To improve the quality of input data, the feature generator 208 pre-processes the raw data in the data repository 201 to handle missing values, normalize numerical features, and encode categorical variables using techniques such as imputation, normalization, and one-hot encoding.

After the pre-processing step, the feature generator 208 extracts relevant features from the preprocessed data. The feature generator 208 first uses a dimensionality reduction technique to reduce the dimensionality of the pre-processed data while retaining as much variance of possible. For example, the feature generator 208 may use Principal Component Analysis (PCA) to linearly transform the pre-processed data onto a new coordinate system such that the directions (principal components) capturing the largest variation in the data can be identified. Once the principal components are identified, the feature generator 208 selects the most significant components that contribute to the majority of the variance. These selected components are then used to construct the user feature vectors, ensuring that the most relevant and informative features are retained for further analysis and engagement resource activation.

After reducing the dimensionality, the feature generator 208 employs techniques such as embeddings and neural networks to represent the data in a meaningful way. For example, in some implementations, the feature generator 208 uses embeddings to transform categorical data into continuous vector spaces. For instance, the feature generator 208 may use word embeddings to represent textual data, where each word is mapped to a dense vector that captures its semantic relationships with other words. Similarly, entity embeddings can be used for other categorical features, such as user demographics or product categories. These embeddings are learned during the training process and help in capturing complex relationships within the data, making it easier for the system to analyze and utilize the information.

In some implementations, the feature generator 208 can use neural networks, such as deep neural networks or convolutional neural networks, to learn representations of the data. For instance, a convolutional neural network can be used to extract features from image data by applying convolutional filters that detect patterns and textures. The extracted features are then passed through pooling layers to reduce dimensionality and fully connected layers to generate user feature vectors. These neural network-based representations can capture intricate patterns and relationships within the data. The convolutional neural network can be trained to generate user feature vectors through backpropagation to optimize the network's parameters by minimizing the error between the predicted and actual outputs.

To further refine the feature selection process, the feature generator 208 may employ techniques such as recursive feature elimination for removing the least important features, and/or ranking features based on feature importance scores using models such as random forests and selecting features that have the highest importance scores.

Machine learning models, such as neural networks, are trained on the selected features to learn patterns and relationships within the data. Techniques such as backpropagation are used to optimize the model's parameters during training. Once the model is trained, it can be used to generate feature vectors for each user.

In addition to the above techniques, in some implementations, the feature generator 208 utilizes the knowledge graph 209 to enhance feature extraction by incorporating structured relationships between entities. The knowledge graph 209 provides a dynamic, connected representation of relationship between one or more of: users, rich engagement resources such as media content, locations, engagement patterns, or contextual factors (including the contextual factors associated with the users such as locations, and external contextual factors such as current or upcoming events), enabling the system to derive richer and more meaningful insights. For example, if the knowledge graph 209 links a user to specific movie genres they frequently engage with and associates those genres with similar music categories, the feature generator 208 can incorporate these relationships as additional features. Similarly, relationships captured in the knowledge graph, such as user affinity for content from a particular studio or artist, can help refine feature selection by identifying higher-order patterns that are not immediately apparent from raw data alone.

By integrating information from the knowledge graph 209, the feature generator 208 ensures that the user feature vectors capture not only statistical variance but also semantic and contextual relationships, leading to more accurate predictions and personalized engagement recommendations. These enriched feature vectors are then used for further analysis and engagement resource activation, optimizing content recommendations and user interactions based on deeper behavioral patterns.

The user feature vector database 210 stores the user feature vectors generated by the feature generator 208. The database 210 ensures that the system 200 can quickly access and utilize these user feature vectors to identify engagement opportunities and deliver personalized content to users.

The target tag to feature vector engine 216 is configured to transform target tags into measurable feature vectors that can be compared with user feature vectors. In particular, the engine 216 receives one or more input tags, such as “Quinn Star fan”, and processes the one or more input tags to generate one or more numerical representations or vectors that represent the one or more input tags. For example, one or more numerical representations or vectors may represent music preferences, past concert attendance, and Quin Star merchandise purchases of a typical Quinn Star fan. Each of these vectors are then used to compare against user feature vectors to determine the likelihood of a user belonging to a target group. This process ensures that engagement resources are directed towards users who exhibit characteristics aligned with the target tag.

The real-time context correlation engine 212 is configured to collect real-time contextual data 218 associated with one or more users, including, for example, data indicating current locations and/or current activities of users. For example, data indicating current locations of users can include GPS coordinates, proximity to known landmarks, or geofenced areas, The real-time context correlation engine 212 is further configured to collect data indicating external real-time context 225 related to the physical environment surrounding the users (e.g., data indicating current or upcoming entertainment or sport events). The engine 212 is configured to correlate the user real-time contextual data 218 associated with the users and the data indicating external real-time context 225 of the physical environment surrounding the users to determine which users are in proximity to which events in real-time.

In some implementations, the real-time context correlation engine 212 is configured to process data indicating the user's current activities. This can include data from wearable devices, such as heart rate or body temperature, indicating physical activity, or data from mobile apps indicating the user's engagement with specific content. By recognizing the user's current activity, the real-time context correlation engine 212 can better understand the real-time context in which the user is operating.

In some implementations, the real-time context correlation engine 212 is configured to process additional real-time data that indicates environmental conditions, such as weather data or time of day, to further refine the context. For example, knowing that a user is outdoors on a sunny day might influence the type of engagement resource that is activated.

The engagement opportunity engine 214 is configured to send an activation signal to the engagement resource activator 220 in order to trigger the engagement resource activator 220 to identify and activate one or more engagement resources when the following conditions are satisfied.

First, the engine 214 accesses the user feature vector database and determine a set of users (including multiple users) whose user feature vectors match a target tag 215. As described above, these user feature vectors are generated by the feature generator 208 based on pre-processed and transformed data that captures user characteristics and preferences.

Next, the engagement opportunity engine 214 queries the real-time context correlation engine 212 to determine an external real-time context related to the target tag 215. The engagement opportunity engine 214 uses the real-time context correlation engine 212 to identify, from the set of users, a subset of one or more target users whose real-time contextual data matches the external real-time context related to the target tag 215.

The engagement opportunity engine 214 determines the availability of one or more engagement resources for the external real-time context and the target tag 215. In some implementations, the engagement opportunity engine 214 checks an engagement resource database of the first party (e.g., the enterprise system) or external sources (e.g., engagement resources provided by third parties) to identify suitable engagement resources that can be activated. In response to determining that the user feature vectors of the set of users match the target tag 215, that the external real-time context is related to the target tag 215, that the real-time contextual data of the one or more target users in the subset of users matches the external real-time context, and that one or more engagement resources are available for the one or more target users given the external real-time context and the target tag, the engagement opportunity engine 214 sends the activation signal to the engagement resource activator 220.

In some implementations, the activation signal includes one or more of: one or more user identifiers associated with the identified one or more target users, one or more user feature vectors associated with the one or more user identifiers, data indicating the external real-time context related to the target tag, or user real-time contextual data associated with the one or more user identifiers.

The engagement resource activator 220 selects appropriate rich engagement resources based on the data included in the activation signal, e.g., based on one or more users' user feature vectors, target tag, user real-time contextual data, and/or external real-time context related to the target tag. In some implementations, the engagement resource activator 220 uses the knowledge graph 209 to enhance the selection process by leveraging structured relationships between users, media content, events, locations, brands, and external influences. The knowledge graph 209 helps the activator 220 infer contextually relevant recommendations by analyzing past user interactions, preferences, and engagement patterns across different content types.

For example, if the knowledge graph indicates that a user frequently listens to a specific music artist, attends concerts, and engages with music-themed video games, the activator 220 can prioritize engagement resources that align with these interests. If a live event featuring the artist is happening nearby, the system may proactively recommend event-related content, such as exclusive backstage footage, live-streamed performances, or a limited-time in-game experience featuring the artist's music.

Conversely, if the knowledge graph shows that a user habitually skips sports-related content, even when suggested in relevant contexts (e.g., a major sporting event nearby), the activator 220 may deprioritize sports-related recommendations and instead suggest alternative entertainment options, such as a trending movie premiere or a local food festival.

The engagement resource activator 220 then activates the selected one or more rich engagement resources for the user within the external real-time context. In some implementations, the activator 220 determines the optimal timing and method for activation to maximize user engagement and satisfaction. These resources may include multimedia presentations, live streaming events, interactive advertisements, exclusive digital rewards, and other personalized content tailored to the user's preferences and current situation.

By continuously analyzing user preferences, real-time context, and available engagement resources, the activator 220 ensures that the system delivers the most relevant and impactful content to users. For instance, as shown in FIG. 1, if a user identified as a “Quinn Star fan” parks their vehicle near a Quinn Star concert venue, the engagement opportunity engine 214 may trigger the engagement resource activator 220 to identify and offer relevant resources, such as displaying a curated Quinn Star concert pre-mix on the infotainment system 102, unlocking exclusive behind-the-scenes content, or providing a special discount for personalized Quinn Star merchandise.

Through this adaptive selection process, the knowledge graph 209 enables the system to deliver highly personalized and meaningful engagement experiences, ensuring that users receive recommendations that truly align with their evolving preferences and situational context.

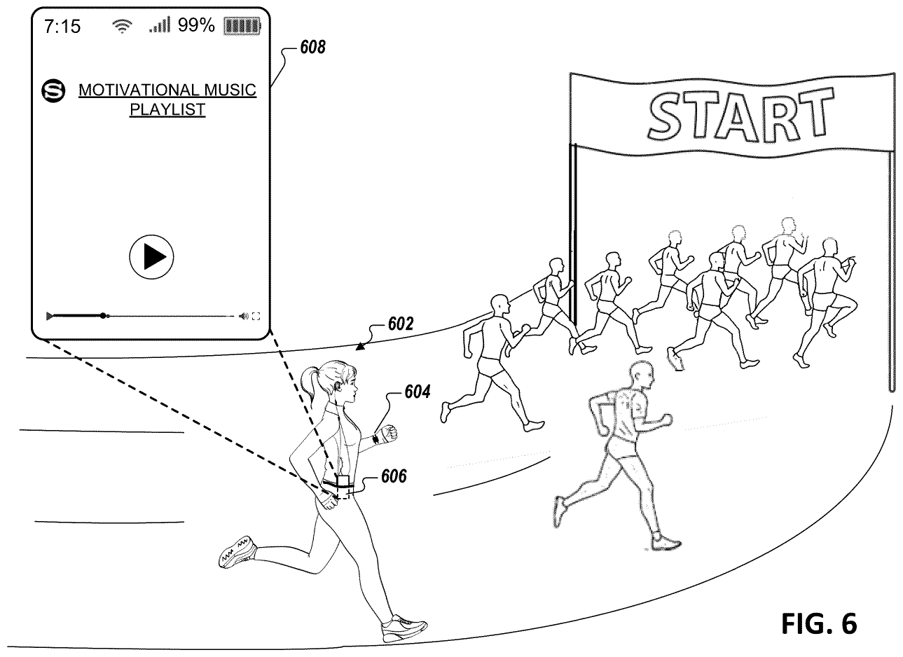

FIG. 6 illustrates another example implementation of the rich engagement resource activation system 200. As shown in FIG. 6, the real-time context correlation engine 212 is configured to receive and process various types of data from user devices to determine the users' current activities and context. For example, the real-time context correlation engine 212 may receive real-time contextual data associated with a user, for example, physiological data from a smartwatch 604 of a user 602. The physiological data may indicate a significant increase in heart rate and body temperature. Additionally, the engine 212 can retrieve location data from the user device 606, and retrieve data indicating an external real-time context in a physical environment surrounding the user. By analyzing the user's location data and the data indicating the external real-time context, the engine 212 can determine that the user is at an event, e.g., at the site of a 5K race. Further, by correlating the physiological data points, location data points, and external real-time context data points, the engagement opportunity engine 214 can infer that the user is participating in the race as the user's heart race and body temperature have significantly increased. Given a target tag of “runner”, the engagement opportunity engine 214 can determine, based on the user 602′s feature vector retrieved from the user feature vector database 210, that the user 602′s feature vector matches the target tag. The engagement opportunity engine 214 can trigger the engagement resource activator 220 to identify and activate relevant engagement resources tailored to the user 602′s current activity. For instance, the engagement resource activator 220 can send motivational messages to the user device 606, stream motivational music via the user device 606 (e.g., a mobile phone or wearable device) as shown on the user interface 608 of the user device 606, or automatically track the user's progress during the event. This personalized and context-aware approach enhances the user's experience and engagement with the system 200.

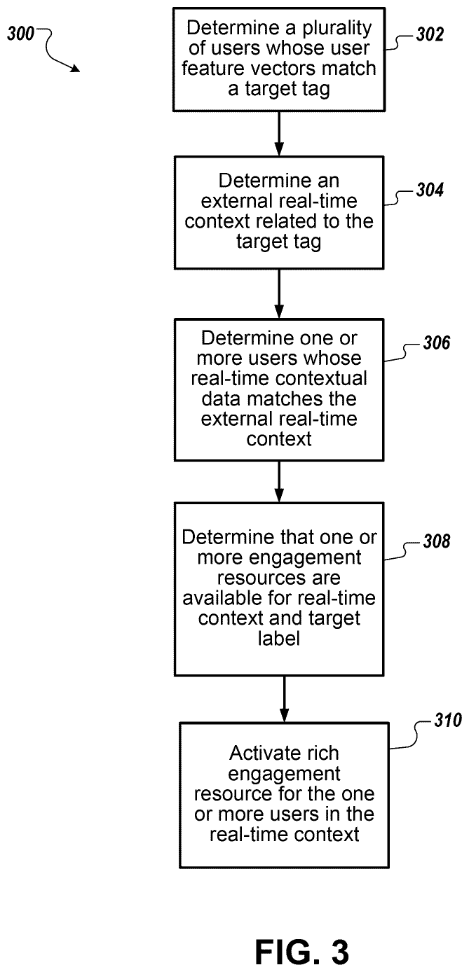

The engagement opportunity engine 214 and the engagement resource activator 220 ensure that the activated resources 222 are delivered at the optimal time and place, enhancing the relevance and timeliness of the resources, thereby improving user engagement and satisfaction. A process for activating rich engagement resources is described in more detail below with reference to FIG. 3.

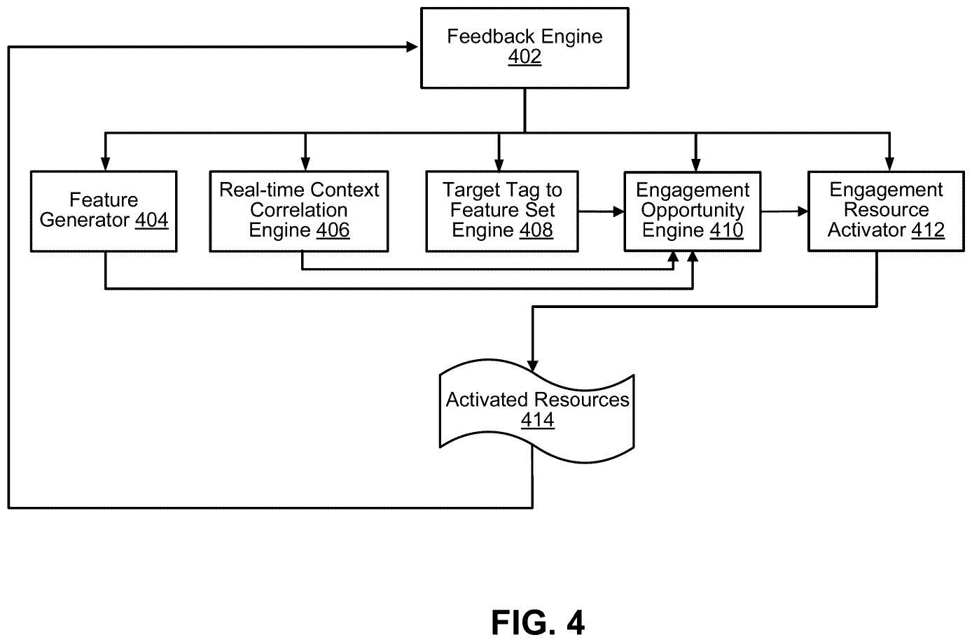

The feedback engine 224 collects feedback on user interactions with the activated rich engagement resources. The feedback engine 224 tracks engagement feedback, such as clicks, likes, and other actions, and feeds this data back into other components of the system 200 (e.g., the feature generator 208, the real-time context correlation engine, the engagement opportunity engine 214, and the target tag to feature vector engine 216) to continuously improve the accuracy and relevance of the engagement resource activation system 200. By analyzing user feedback, the system 200 can refine its models and algorithms to better understand user preferences and optimize future engagement opportunities. A process for using feedback associated with the activation of rich engagement resources to tailor rich engagement resources is described in more detail below with reference to FIG. 4.

The engagement resource activation system 200 enables enterprises with diverse businesses, such as entertainment, electronics, gaming, and more, to deliver personalized and contextually relevant engagement resources to users. By integrating diverse data sources and real-time contextual information, the system 200 can dynamically select and present rich engagement resources that align with user preferences and situational contexts. This approach enhances user engagement and satisfaction by providing timely and relevant content.

FIG. 3 is a flow diagram of an example process 300 for activating rich engagement resource. For convenience, the process 300 will be described as being performed by a system of one or more computers located in one or more locations. For example, an engagement resource activation system, e.g., the engagement resource activation system 200 of FIG. 2, appropriately programmed, can perform the process 300.

The system determines a plurality of users whose user feature vectors match a target tag (step 302). In some implementations, the system determines, for each of the user feature vectors, a similarity score the user feature vector and a feature vector representing the target tag. If the similarity between a user feature vector and a feature vector representing the target tag exceeds a threshold level of similarity, the system determines that the user feature vector matches the target tag.

In some implementations, determining a user refers to identifying a specific individual user. In other implementations, determining a user refers to identifying a user profile, where the user identity is anonymized or not directly tied to any personally identifiable information. This allows the system to focus on user behaviors or characteristics without exposing the user's real identity. The use of anonymized user profiles helps preserve privacy while still enabling accurate matching of user feature vectors to target tags.

In particular, the similarity score can be a numerical value that quantifies the degree of similarity between a user feature vector and a feature vector representing the target tag. The system may employ various methods to calculate the similarity score, including but not limited to cosine similarity, which measures the cosine of the angle between two vectors, Euclidean distance, which calculates the straight-line distance between two vectors in a multi-dimensional space, or Manhattan distance, which sums the absolute differences between the coordinates of two vectors. The system then compares the similarity score a predefined threshold to determine whether the user feature vector sufficiently matches the target tag feature vector, thereby indicating a match. The target tag may represent a user interest or preference.

In some implementations, before determining the plurality of users whose user feature vectors match a target tag, the system generates user feature vectors and stores the user feature vectors in a user feature vector database. In particular, the system receives raw data from a data repository, in which the raw data comprises first-party media engagement data, first-party other data, and third-party data. The system generates user feature vectors from the raw data, by pre-processing the raw data to address missing values, normalize numerical features, and encode categorical variables, applying dimensionality reduction techniques to the pre-processed data to retain features having variance exceeding a threshold, and transforming, using a machine learning model, the pre-processed and reduced-dimensionality data into user feature vectors, wherein each user feature vector is a numerical representation of characteristics and preferences of the respective user.

The system determines an external real-time context related to the target tag (step 304). This involves analyzing data indicating current events or upcoming activities in the physical environment surrounding the users that are relevant to the target tag. For example, if the target tag is related to a specific interest or event, the system identifies external real-time contexts that align with this tag. This step ensures that the engagement resources are activated in a context that is meaningful and relevant to the users.

The system determines, among the plurality of users, one or more users whose real-time contextual data matches the real-time context (step 306). In some implementations, the real-time contextual data includes location data, and determining that the real-time contextual data matches the real-time context comprises comparing the location data with a plurality of event locations. In some implementations, the real-time contextual data includes activity data from user devices, and wherein determining that the real-time contextual data matches the real-time context comprises analyzing the activity data to identify user activities in the real-time context.

The system determines that one or more engagement resources are available for the one or more user given the external real-time context and the target tag (step 308). In particular, the system may query an enterprise's databases or external third-party systems to identify suitable engagement resources that can be activated. The enterprise database may be part of a comprehensive system, such as an enterprise's engagement resource management system, which includes a wide array of multimedia content, live streaming events, music/video streaming services, gaming content, and other interactive resources. The system may also interface with third-party systems via APIs to access additional engagement resources, such as news streaming services or social media networks.

In response to determining that the user feature vectors of the plurality of users match the target tag, that the real-time context is related to the target tag, that the real-time contextual data of the one or more users matches the real-time context, and that one or more engagement resources are available for the one or more users given the external real-time context and the target tag, the system activates rich engagement resources for the one or more users in the real-time context (step 310). The system identifies engagement resources that are appropriate for the external real-time context and the target tag by evaluating the relevance and suitability of each resource. For example, the system may check metadata, tags, and contextual information associated with the engagement resources to ensure they align with the one or more users' interests and the current context. For example, if the external real-time context involves a live concert event, the system may prioritize engagement resources such as live streaming of the concert, exclusive backstage content, or interactive fan experiences.

By leveraging both enterprise and third-party systems, the system can provide a personalized and relevant experience for the users, ensuring that the engagement resources activated are tailored to their preferences and the real-time context in which they are operating.

The system transmits one or more rich engagement resources to one or more user devices of the one or more users. In some implementations, the one or more user devices includes at least one of a mobile device, an infotainment system of a vehicle, a wearable device, a gaming console, a smart TV, a laptop or a desktop computer.

In some implementations, the rich engagement resources includes one or more of: music streaming content, movie streaming content, news streaming content, interactive music playlists, live streaming of events, gaming content, in-game rewards, interactive advertisements, video ads, virtual reality experiences, augmented reality experiences, personalized video messages, e-books, audiobooks, podcasts, webinars, online courses, interactive quizzes, social media interactions, mobile app notifications, multimedia presentations, personalized offers, discount coupons, or personalized merchandise offers.

FIG. 4 illustrates an example feedback system 400 for using feedback associated with the activation of rich engagement resources to tailor rich engagement resources. The feedback system 400 includes a feedback engine 402 which interacts with other components within the rich engagement resource activation system. The system 400 is an example of a system implemented as computer programs on one or more computers in one or more locations, in which the systems, components, and techniques described below can be implemented.

The feedback engine 402 is configured to collect feedback on user interactions with activated rich engagement resources 414. The feedback engine 402 tracks various user engagement metrics, such as clicks, likes, shares, and other user actions, and processes this data to generate feedback data.

The feedback engine 402 transmits the feedback data to other components within the system 200 to enhance the accuracy and relevance of future engagement resource activations. In particular, the feedback engine 402 transmits feedback data to the feature generator 404, the real-time context correlation engine 406, the target tag to feature vector engine 408, and the engagement opportunity engine 410.

The feature generator 404 utilizes the feedback data to refine its machine learning models and improve the generation of user feature vectors. By incorporating engagement feedback, the feature generator 404 can better capture user preferences and behaviors, resulting in more accurate and meaningful feature vectors. This targeted refinement reduces the need for extensive computational resources by focusing on the most relevant features, thereby streamlining the data processing and analysis. Compared to existing engagement activation systems, this approach significantly reduces the computational load by avoiding the processing of less relevant data.

In some implementations, the knowledge graph (e.g., the knowledge graph 209 of FIG. 2) is configured to receive the feedback data and process the feedback data to update the relationships and connections between entities such as users, media content, genres, businesses, sports, sports-themed video games, music, movies, and external influences. By incorporating engagement feedback, the knowledge graph can refine its structure to better represent the evolving preferences and behaviors of users.

For example, if a user frequently watches basketball games and engages with basketball simulation games, the knowledge graph can strengthen the association between these interests, allowing the system to make more informed recommendations. Similarly, if a user streams action movies regularly and listens to rock music, the system may recognize a pattern and suggest action movies with rock soundtracks or recommend playlists featuring artists frequently used in action film scores. Conversely, if a user consistently ignores or dismisses recommendations related to certain sports, movies, or music genres, such as skipping suggested romantic movies, never engaging with jazz playlists, or avoiding fantasy football content, the knowledge graph can weaken or remove those associations. Additionally, if a user is recommended a newly released movie from a franchise they previously engaged with but does not interact with it, the system may infer a shift in preference and deprioritize similar recommendations in the future.

This adaptive approach ensures that the system does not persistently recommend content that does not align with the user's actual interests. The updated knowledge graph is then utilized by the feature generator 404 to generate user feature vectors that more accurately represent users' preferences and characteristics. In some implementations, the updated knowledge graph is utilized by the engagement resource activator 412 to deliver more accurate and relevant engagement resources to target users.

The real-time context correlation engine 406 uses the feedback data to enhance its understanding of real-time contextual factors that influence user engagement. By analyzing feedback on user interactions, the real-time context correlation engine 406 can more accurately correlate users' real-time contextual data with the external real-time context relevant to a target tag, improving the relevance of activated engagement resources. This improved correlation reduces the computational burden by minimizing the need to process large volumes of irrelevant contextual data related to the users themselves and to the physical environment where the users are located. In comparison to existing systems, this method ensures more efficient use of computational resources by focusing on the most impactful contextual factors.

The target tag to feature vector engine 408 processes the feedback data to optimize the transformation of target tags into measurable feature vectors. By incorporating engagement feedback, the target tag to feature vector engine 408 can more effectively identify and represent characteristics of target user groups, ensuring that engagement resources are directed towards users who exhibit the desired traits. For example, returning to FIG. 1, if the driver does not select any options provided on the user interface 104 of the infotainment system 102, it could mean that the driver is not a Quinn Star fan. In this case, the engine 408 may re-generate a feature vector that more accurately represent characteristics of a “Quinn Star fan”. The engine 408 can transmit the re-generated feature vector to the engagement opportunity engine 410 so that the engine 410 more accurately identifies one or more users who are likely Quinn Star fans (i.e., by determining one or more user feature vectors that match the re-generated feature vector). This optimization process eliminates the waste of computational resources used to send engagement resources to incorrectly targeted users who do not fall into the target groups, focusing only on the target users.

The engagement opportunity engine 410 utilizes the feedback data from the feedback engine 402, along with optionally updated data from the feature generator 404, the real-time context correlation engine 406, and the target tag to feature set engine 408 to refine its criteria for identifying and triggering engagement opportunities. By analyzing engagement feedback, the engagement opportunity engine 410 can improve its ability to match user feature vectors with target tags and correlate users' real-time contextual data with data indicating external real-time context, resulting in more timely and relevant engagement resource activations. This refinement reduces the computational load by prioritizing the most promising engagement opportunities and avoiding the processing of less relevant data. Compared to existing systems, this method ensures that computational resources are used more effectively by focusing on high-impact opportunities that will likely result in positive user engagement.

The engagement resource activator 412 receives feedback data from the feedback engine 402 and an activation signal from the engagement opportunity engine 410. Based on the received input, the engagement resource activator 412 identifies and activates rich engagement resources 414 that are more relevant compared to the resources transmitted to users in the previous iteration.

For example, the engagement resource activator 412 may employ a multi-armed bandit algorithm to update a probability distribution of rich engagement resources. Each value in this distribution represents the probability of success (e.g., engagement or conversion rate) for each resource. By using real-time feedback, the system 200 can prioritize engagement resources with higher probabilities of success. The resources 414 with the highest probability of success are delivered to one or more identified users. The feedback engine 402 then collects feedback on user interactions with these resources, completing the feedback loop.

By continuously incorporating engagement feedback into various components of the rich engagement resource activation system, the feedback engine 402 ensures that the rich engagement resource activation system 200 can dynamically adapt and improve its performance, delivering increasingly relevant and impactful content to users. This feedback-driven approach reduces the computational resources required to handle large volumes of diverse data by focusing on the most relevant and timely resources. As a result, the system 200 can operate more efficiently and cost-effectively compared to existing engagement activation systems, avoiding the pitfalls of outdated or irrelevant content that can negatively impact user experience and engagement.

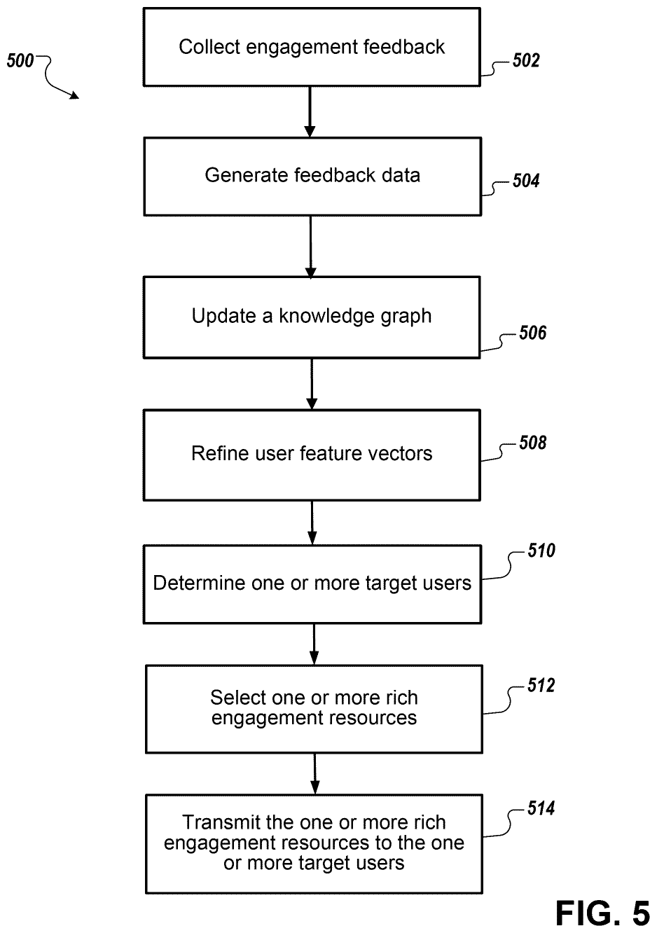

FIG. 5 is a flow diagram of an example process 500 for using feedback associated with the activation of rich engagement resources to tailor rich engagement resources. For convenience, the process 500 will be described as being performed by a system of one or more computers located in one or more locations. For example, a rich engagement resource activation system e.g., the system 200 of FIG. 2, appropriately programmed, can perform the process 500. The system collects engagement feedback on one or more rich engagement resources (step 502). This feedback can come from explicit user actions or be implicitly inferred from user behavior, movements, or device interactions. In some implementations, the system collects explicit engagement feedback includes one or more direct actions such as one or more of clicks, shares, likes, skips, dismissals, purchases, or interaction duration with the activated rich engagement resources. These signals can indicate interest or disinterest. For example, if a user clicks on a recommended article and reads it in full, this suggests strong engagement, while skipping a video or dismissing a suggestion implies disinterest. Similarly, purchasing a recommended product is a strong indicator of relevance, whereas quickly navigating away from a suggested item may indicate that it was not useful.

In addition to direct actions, the system can collect implicit engagement feedback which can be inferred from location data, and device interactions. For instance, if the system recommends an event and detects that the user's car is navigating toward the event location, this serves as a positive engagement signal. Other implicit signals include voice assistant interactions (asking for more details versus ignoring a recommendation), and biometric or IoT-based feedback. Wearable devices, for example, might detect an increase in heart rate when engaging with a recommended video, suggesting excitement. Similarly, smart home devices, such as a smart TV or speaker, can register whether a user follows through with a suggested show or song. By combining both explicit and implicit engagement signals, the system can refine future recommendations to better align with the user's interests. The system processes the engagement feedback to generate feedback data (step 504).

The system updates a knowledge graph based on the feedback data. The knowledge graph is a dynamic representation of relationships between one or more of users, rich engagement resources, locations, or contextual factors (step 506). In some implementations, the knowledge graph is adaptively updated to strengthen or weaken relationships between users and rich engagement resources based on positive or negative user engagement feedback.

The system refines user feature vectors stored in a user feature vector database based on the feedback data and the updated knowledge graph (step 508).

The system determines one or more target users based on the refined user feature vectors and a target tag (step 510). In some implementations, determining the one or more target users based on the refined user feature vectors and a target tag includes identifying a plurality of users whose user feature vectors, based on the refinement, match a target tag; determining an external real-time context relevant to the target tag; and determining, among the plurality of users, one or more target users whose real-time contextual data matches the external real-time context.

In some implementations, to identify the plurality of users whose user feature vectors, based on the refinement, match the target tag, the system calculates, for each user feature vector, a similarity score between the user feature vector and the feature vector representing the target tag; and determines that the similarity score exceeds a predefined threshold.

In some implementations, the target tag represents a user interest or preference.

In some implementations, the real-time contextual data includes location data, and determining that the real-time contextual data matches the external real-time context comprises comparing the location data with a plurality of event locations.

In some implementations, the real-time contextual data includes activity data from user devices, and wherein determining that the real-time contextual data matches the external real-time context comprises analyzing the activity data to identify user activities in the external real-time context.

The system selects one or more rich engagement resources based on the user feature vectors of the one or more target users and the external real-time context (step 512). In some implementations, the system updates a probability distribution of a plurality of rich engagement resources, for example, based on the feedback data and the updated knowledge graph. Each value in the distribution represents a probability of success of each of the plurality of rich engagement resources. The system then selects the one or more rich engagement resources having the highest probabilities of success.

In some implementations, the one or more rich engagement resources include one or more of: music streaming content, movie streaming content, news streaming content, interactive music playlists, live streaming of events, gaming content, in-game rewards, interactive advertisements, video ads, virtual reality experiences, augmented reality experiences, personalized video messages, e-books, audiobooks, podcasts, webinars, online courses, interactive quizzes, social media interactions, mobile app notifications, multimedia presentations, personalized offers, discount coupons, or personalized merchandise offers.

The system transmits the one or more selected rich engagement resources to one or more user devices of the one or more target users in the external real-time context (step 514). In some implementations, the one or more user devices comprise at least one of a mobile device, an infotainment system of a vehicle, a wearable device, a gaming console, a smart TV, a laptop or a desktop computer.

In some implementations, the system uses a real-time context correlation engine to adjust the selection of the one or more rich engagement resources based on a correlation between user real-time contextual data and data indicating an external real-time context in a physical environment surrounding the one or more target users.

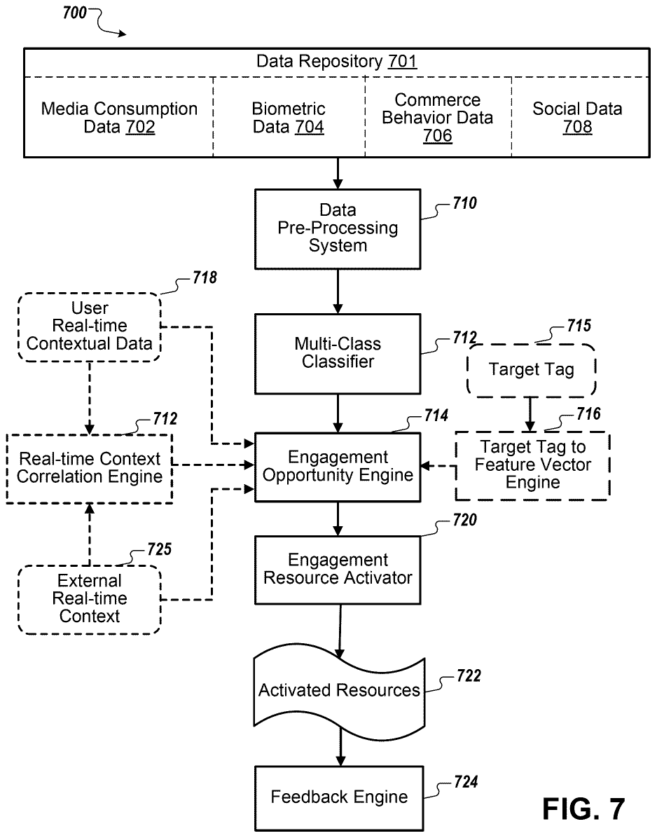

FIG. 7 is another example engagement resource activation system. The rich engagement resource activation system 700 is an example of a system implemented as computer programs on one or more computers in one or more locations, in which the systems, components, and techniques described below can be implemented.

The system 700 can advantageously determine a classification of a type of user for a particular user (e.g., a fan) based on user interactions with media. For example, the user can be a type of fan of a subject, and the described system 700 can determine their type of “fanhood’ based on multiple types of data associated with a level of sentiment of the user towards the particular subject (e.g., an entity, an object, an event, a time, a location, or content).

The system 700 includes a data repository 701, a data pre-processing system 710, a multi-class classifier 712, an engagement opportunity engine 714, a real-time context correlation engine 712, a target tag to feature vector engine 716, an engagement resource activating engine (or “engagement resource activator”) 720, and a feedback engine 724. In some examples, the an engagement opportunity engine 714, a real-time context correlation engine 712, a target tag to feature vector engine 716, an engagement resource activating engine (or “engagement resource activator”) 720, and a feedback engine 724 can be the same as the engagement opportunity engine 214, real-time context correlation engine 212, target tag to feature vector engine 216, an engagement resource activating engine (or “engagement resource activator”) 220, and feedback engine 224 of FIG. 2, respectively.

In some implementations, the data pre-processing system, multi-class classifier 712, engagement opportunity engine 714, real-time context correlation engine 712, target tag to feature vector engine 716, and engagement resource activator 720 run in parallel and can operate asynchronously. This parallel and asynchronous execution enables the rich engagement resource activation system 700 to process engagement feedback, contextual data, and engagement opportunities in real time, improving responsiveness and personalization.

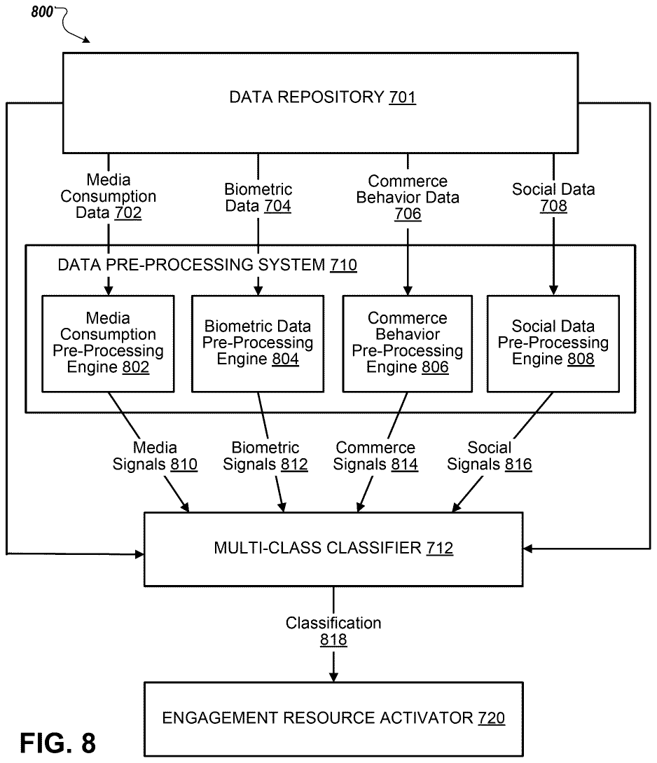

The data repository 701 stores various types of data, including media consumption data 702, biometric data 704, commerce behavior data 706, and social data 708, as described in more detail below with reference to FIG. 8.

Media consumption data 702 includes information about user interactions for a particular user with media content, such as games, streaming content, movies, music, and other entertainment activities. The media content may be provided by different businesses or systems within the enterprise, each specializing in various forms of entertainment. For example, one business unit might focus on gaming, another on music, and yet another on movies and streaming services.

Biometric data 704 includes biological information about a user, such as heart rate data, facial recognition data, and/or voice recognition data. In some examples, the biometric data 704 can be collected by a biometric device associated with the user. For example, the biometric device can be a wearable device such as a smartwatch or a fitness tracker, a facial recognition camera, or a voice recognition microphone.

Commerce behavior data 706 encompasses additional user-related information, such as purchase history, transactional patterns, and spending habits across different platforms. This data includes details on the frequency, timing, and monetary value of purchases, providing insights into a user's purchasing power and preferences. For instance, the system can analyze whether a user frequently buys premium content, subscribes to services, or engages in impulse purchases versus planned spending. Additionally, commerce behavior data 706 can track abandoned carts, refund requests, and promotional response rates, helping to determine user intent and engagement levels. By integrating this data with other behavioral signals, such as media consumption and social interactions, the system can better classify user types, distinguishing between casual browsers, engaged buyers, and high-value customers.

Social data 708 encompasses additional user-related information, such as social media activity associated with one or more social media websites/platforms for the particular user. The data repository 701 ensures that the system 700 has access to a comprehensive and diverse set of data points to accurately represent user preferences and behaviors.

The data pre-processing system 710 processes the raw data from the data repository 701 to generate multiple corresponding data signals, which are numerical representations of the corresponding data. Each data signal represents characteristics and preferences of the particular user based on the particular type of data. In particular, the data pre-processing system 710 can process the media consumption data 702, the biometric data 704, the commerce behavior data 706, and the social data 708 to generate multiple corresponding data signals, as described in further detail below with reference to FIG. 8. In some examples, the data pre-processing system 710 can normalize the media consumption data 702, the biometric data 704, the commerce behavior data 706, and the social data 708 to generate the multiple corresponding data signals. The data pre-processing system 710 can then provide the multiple corresponding data signals to the multi-class classifier 712.

In some implementations, rather than processing and transmitting all available data, the data pre-processing system 710 detects and selects only meaningful signals-data points that exhibit significant variations, patterns, or correlations relevant to classification. For example, instead of continuously sending a user's baseline heart rate, the system 710 may identify and extract moments of physiological response, such as an elevated heart rate when the user is watching an intense movie trailer or playing a high-stakes game level. Similarly, in the context of commerce behavior data, the system 710 may prioritize signals related to a sudden increase in spending on a specific product category or a user's reaction to a limited-time offer, rather than routine purchases. For social data, meaningful signals could include a user posting enthusiastically about an upcoming event or engaging in a high volume of interactions within a fan community, rather than regular passive browsing. By filtering out routine or low-impact data and focusing on signals that reflect key behavioral patterns, the system 710 improves the accuracy and classification efficiency of the multi-class classifier 712 while reducing computational complexity.

The multi-class classifier 712 processes the data signals from the data pre-processing system 710 to generate a classification of a type of the user. After the pre-processing step, the multi-class classifier 712 extracts relevant features from the preprocessed data by employing techniques such as embeddings and neural networks to represent the data in a meaningful way. For example, in some implementations, the multi-class classifier 712 uses embeddings to transform categorical data into continuous vector spaces. For instance, the multi-class classifier 712 may use word embeddings to represent textual data, where each word is mapped to a dense vector that captures its semantic relationships with other words. Similarly, entity embeddings can be used for other categorical features, such as user demographics or product categories. These embeddings are learned during the training process and help in capturing complex relationships within the data, making it easier for the system to analyze and utilize the information.

In some implementations, the multi-class classifier 712 can use neural networks, such as deep neural networks or convolutional neural networks, to learn representations of the data. In some examples, the multi-class classifier 712 can include a rule-based classifier configured to classify the type of user based on a respective threshold value assigned to each classification. In this case, the rules can be created using expert knowledge or learned from a set of labeled training data That is, the system can assign threshold scores to each of the respective signal scores, and the multi-class classifier 712 can generate the classification 818 based on the threshold scores. In particular, the rule-based classifier can define a set of rules that can be used to assign class labels to new instances based on their features, as described in further detail below with reference to FIG. 8. The multi-class classifier 712 can then provide the classification of the type of user to the engagement opportunity engine 714.

The engagement opportunity engine 714 is configured to send an activation signal to the engagement resource activator 720 in order to trigger the engagement resource activator 720 to identify and activate one or more engagement resources.

In some implementations, the engine 714 can determine, among the classified users, one or more uses whose user types match a predefined target tag 215.

In some implementations, the engagement opportunity engine 714 queries the real-time context correlation engine 712 to determine an external real-time context related to the predefined target tag 715. The engagement opportunity engine 714 can use the real-time context correlation engine 712 to identify, from the set of classified users, a subset of one or more target users whose real-time contextual data matches the external real-time context related to the target tag 715. For example, the engagement opportunity engine 714 can use the real-time context correlation engine 712 to identify a subset of one or more target users with a same classification of a type of user.

The engagement opportunity engine 714 determines the availability of one or more engagement resources for the external real-time context and the target tag 715. In some implementations, the engagement opportunity engine 714 checks an engagement resource database of the first party (e.g., the enterprise system) or external sources (e.g., engagement resources provided by third parties) to identify suitable engagement resources that can be activated. In response to determining that the one or more engagement resources are available for the one or more target users given the external real-time context and the target tag, the engagement opportunity engine 714 sends the activation signal to the engagement resource activator 720.

In some implementations, the activation signal includes one or more of: one or more user identifiers associated with the identified one or more target users, one or more user feature vectors associated with the one or more user identifiers, data indicating the external real-time context related to the target tag, user real-time contextual data associated with the one or more user identifiers, or data indicating the classification of the type of user.

The engagement resource activator 720 selects appropriate rich engagement resources based on the data included in the activation signal, e.g., based on the classification of the type of user and one or more of the user feature vectors, target tag, user real-time contextual data, or external real-time context related to the target tag. In some implementations, the engagement resource activator 720 can use a knowledge graph (e.g., the knowledge graph 209 of FIG. 2) to enhance the selection process by leveraging structured relationships between users, media content, events, locations, brands, and external influences.

The engagement resource activator 720 then activates the selected one or more rich engagement resources for the user within the external real-time context.

In some implementations, after receiving a classification of a type of a particular user (or classifications of types of multiple users) from the multi-class classifier 712, the engagement opportunity engine 714 can directly send an activation signal to the engagement resource activator 720, without consulting the real-time context correlation engine 712 and the target tag to feature vector engine 716.

In some implementations, the activator 720 determines the optimal timing and method for activation to maximize user engagement and satisfaction. These resources may include multimedia presentations, live streaming events, interactive advertisements, exclusive digital rewards, and other personalized content tailored to the user's preferences and current situation.

The feedback engine 724 collects feedback on user interactions with the activated rich engagement resources 722. The feedback engine 724 tracks engagement feedback, such as clicks, likes, and other actions, and feeds this data back into other components of the system 700 (e.g., the data repository 701, the data pre-processing system 710, the multi-class classifier 712, the engagement opportunity engine 714, and the engagement resource activator 720) to continuously improve the accuracy and relevance of the engagement resource activation system 700. As the user continues to interact with the system, their behavioral patterns and feedback signals are continuously analyzed and new training data is constantly fed to the multi-class classifier 712 for training the classifier 712. Based on new interactions of a user, the multi-class classifier 712 can dynamically change a classification of a user. For instance, a user initially classified as an average user may frequently begin liking and commenting on specific content types. In response, the multi-class classifier 712 might reclassify them as an enthusiast user. If the user then begins to share content externally, engage in discussions, or respond to personalized prompts at an increasing rate, they could be reclassified as a super-enthusiast user (e.g., a superfan). Conversely, a user exhibiting negative behavior, such as repeatedly disliking content, leaving critical comments, or blocking suggested content, might be identified as a detracting user (e.g., a hater or anti-fan).

By continuously analyzing user preferences, feedback, real-time context, available engagement resources, and classifications of a type of user, the system 700 ensures that it delivers the most relevant and impactful content to users. For instance, as shown in FIG. 1, if a user identified as a “Quinn Star fan” parks their vehicle near a Quinn Star concert venue, the engagement opportunity engine 714 may trigger the engagement resource activator 720 to identify and offer relevant resources, such as displaying a curated Quinn Star concert pre-mix on an infotainment system (e.g., the infotainment system 102), unlocking exclusive behind-the-scenes content, or providing a special discount for personalized Quinn Star merchandise. That is, if the user is classified as a “super-enthusiast” user, the system can display access to VIP forums for Quinn Star, beta programs related to Quinn Start, or invitations to special Quinn Start events, as described in further detail below with reference to FIG. 8. As such, the system can deliver highly personalized and meaningful engagement experiences, ensuring that users receive recommendations that truly align with their evolving preferences and situational context.

FIG. 8 illustrates an example system for using user data to generate a classification of a type of user. The example system 800 is an example of a system implemented as computer programs on one or more computers in one or more locations, in which the systems, components, and techniques described below can be implemented.

The described system can process data associated with a particular user to generate a classification of the type of user based on a particular level of sentiment of the user towards one or more subjects. The classification of the user can be an average user, a detracting user (e.g., a hater, an anti-fan, etc.), an enthusiast user (e.g., a fan), and a super-enthusiast user (e.g., a superfan). In particular, an average user can be a casual user that engages sporadically without a strong sentiment towards a subject. A detracting user can be a user that engages with a subject with negative sentiment. An enthusiast user can be a user that demonstrates consistent engagement with moderate sentiment towards the subject. A super-enthusiast user can be a user that demonstrates sustained engagement, high anticipation, and social amplification towards the one or more subjects.

The one or more subjects can be an entity (e.g., a celebrity, a music band, an actor/actress, an artist, a musician, a composer, an influencer, etc.), an object (e.g., a type of car, a clothing item, etc.), an event (e.g., a sports tournament, a music festival, etc.), a time (e.g., a holiday, a time of year, a season, etc.), a location (e.g., a travel destination, a location of a particular event, etc.), or content (e.g., a song, a book, a movie, a television show, etc.).

In general, the system can provide multi-source data from multiple platforms to the data pre-processing system 710 to generate one or more data signals, and the system can provide the one or more data signals to the multi-class classifier 712 to generate the classification of the type of user. The system can then provide the classification to the engagement resource activator 720. Based on the classification, the engagement resource activator 720 can select and deliver tailored content to the user.

In particular, the system can provide media consumption data 702, biometric data 704, commerce behavior data 706, and social data 708 to the data pre-processing system 710 from the data repository 701.

The media consumption data 702 includes information about user interactions for a particular user with media content, such as games, streaming content, movies, music, and other entertainment activities. For example, the media consumption data 702 can include hours spent interacting with a particular game, a particular movie franchise, a particular TV show, or a combination thereof. As another example, the media consumption data 702 can include data associated with the user replaying trailers, cutscenes, or theme music corresponding to a particular type of media.

The biometric data 704 includes biological information about a user, such as heart rate data, facial recognition data, and/or voice recognition data. In some examples, the biometric data 704 can be collected by a biometric device associated with the user. For example, the biometric data 704 can include data indicating a heart rate spike of the user during a key media moment, such as a concert. In another example, the biometric data 704 can indicate movement activity for the user during the key media moment, such as cheering during an event. As another example, the biometric data 704 can include facial recognition data or voice recognition data for the user collected from the biometric device.

The commerce behavior data 706 encompasses additional user-related information, such as purchase history. For example, the commerce behavior data 706 can include purchase history indicating purchasing of limited-edition merchandise, pre-ordering media, such as video games, and/or subscriptions to premium media content. In addition, the commerce behavior data 706 may also include transactional patterns, and spending habits across different platforms. This data includes details on the frequency, timing, and monetary value of purchases, providing insights into a user's purchasing power and preferences. For instance, the system can analyze whether a user frequently buys premium content, subscribes to services, or engages in impulse purchases versus planned spending. Additionally, commerce behavior data 706 can track abandoned carts, refund requests, and promotional response rates, helping to determine user intent and engagement levels. By integrating this data with other behavioral signals, such as media consumption and social interactions, the system can better classify user types, distinguishing between an average user (e.g., a casual browser), an enthusiast user (e.g., an engaged buyer), and a super-enthusiast user (e.g., a frequent customer).

Social data 708 encompasses additional user-related information, such as social media activity associated with one or more social media websites/platforms for the particular user. For example, the social data 708 can include data that indicates that the user is planning to attend a particular event, such as a concert or a sports tournament. As another example, the social data 708 can include data that indicates social media activity, such as posting, sharing, or commenting from the user regarding a particular subject. As another example, the social data 708 can include data that indicates that the user is part of one or more official fan communities, such as membership in official groups, participation in discussions, or engagement with influencer content. Based on the social data 708, the system may also analyze sentiment in posts and comments to assess whether a user expresses enthusiasm, criticism, or neutral interest toward a subject. By integrating these insights with other behavioral signals, such as commerce activity and biometric responses, the system can more accurately classify users, distinguishing between an average user (e.g., a passive follower), an enthusiast user (e.g., an engaged fan), and a super-enthusiast user (e.g., a highly influential advocate).

Unlike conventional recommendation systems that only process consumption data such as hours of engagement and financial conversions, the data pre-processing system 710 is configured to perform cross-domain data aggregation, by process cross-domain data including the media consumption data 702, the biometric data 704, the commerce behavior data 706, and the social data 708 to generate one or more data signals. The one or more data signals can each correspond to the different types of data from the data repository 701. The data pre-processing system 710 can include a media consumption pre-processing engine 802, a biometric pre-processing engine 804, a commerce behavior pre-processing engine 806, and social data pre-processing engine 808. Each pre-processing engine can process data to generate one or more corresponding signals by normalizing the different types of data. Each pre-processing engine is a software-based system, subsystem, or process that is programmed to perform one or more specific functions. Generally, each engine will be implemented as one or more software modules or components, installed on one or more computers in one or more locations. In some cases, one or more computers will be dedicated to a particular engine; in other cases, multiple engines can be installed and running on the same computer or computers.

In particular, the system can process the media consumption data 702 using the media consumption pre-processing engine 802 to generate the media signals 810. The system can process the biometric data 704 using the biometric data pre-processing engine 804 to generate the biometric signals 812. The system can process the commerce behavior data 706 using the commerce behavior pre-processing engine 806 to generate the commerce signals 814. The system can process the social data 708 using the social data pre-processing engine 808 to generate the social signals 816. The data pre-processing system 710 can normalize the different signals by converting each of the signals into similar scales. That is, the system can use one or more statistical techniques for normalization, such as min-max scaling, z-score standardization, and/or time-weighted adjustment. For example, the system can ensure that different types of data, such as hours playing a video game and user purchase frequency, are converted to a same scale useful for training, In some examples, the system can convert the data to similar scales based on temporal activity data to identify trends in behavior (e.g., excitement before an event and post-launch engagement).

The system can then process the media signals 810, the biometric signals 812, the commerce signals 814, and the social signals 816 using the multi-class classifier 712 to generate a classification 818 of the type of user.

In some examples, the multi-class classifier 712 can be a trained classifier neural network (e.g., a deep neural network). In some examples, the multi-class classifier 712 is configured to generate respective scores for each of the signals, such as a media consumption score, a biometric score, a commerce behavior data score, and a social data score, That is, the multi-class classifier 712 can be trained to generate the classification 818 by processing data associated with a user. In particular, the last layer (e.g., the softmax layer) of the multi-class classifier 712 can generate a probability distribution over the different classifications of a type of user (e.g., an average user, a detracting user, an enthusiast user, and a super-enthusiast user). The system can then use the multi-class classifier 712 to classify the type of user based on the highest probability of the respective probabilities. In this case, the system leverages the neural network to predict a classification based on complex, non-linear human behavior. For example, if a user watches trailers (e.g., has a high media consumption score) but does not buy anything associated with the media (e.g., has a low commerce behavior score), the multi-class classifier 712 can be configured to generate a classification by determining whether they are a super-enthusiast, or simply just a curious user.

To train the multi-class classifier 712, the system employs backpropagation and gradient descent to optimize an objective function, typically a categorical cross-entropy loss. During training, the system feeds labeled training data into the classifier neural network. The training data includes multiple training examples. Each training example includes (i) a training input including one or more biometric signals and at least one of one or more media signals, one or more commerce signals, or one or more social signals associated with a user; and (ii) a ground-truth output that indicates a type of the user. The classifier processes each training input through multiple layers, computing intermediate representations before producing a predicted classification output which is a probability distribution over a plurality of user types in the final softmax layer. The system then compares the predicted classification output with the actual label and calculates a loss that represents a prediction error. Using backpropagation, the system computes the gradient of this loss with respect to the network's parameters (weights and biases) by propagating the error backward through the layers. Gradient descent (or a variant such as Adam or RMSprop) then updates these parameters in the direction that minimizes the loss, iteratively refining the classifier's ability to distinguish between user types. Over multiple training epochs, this process allows the multi-class classifier 712 to learn complex, non-linear patterns in user behavior and improve its predictive accuracy.

In some examples, the multi-class classifier 712 can be a rule-based classifier. In this case, the system can use the multi-class classifier 712 to classify the type of user based on a respective threshold value assigned to each classification. That is, the system can assign threshold scores to each of the respective signal scores, and the multi-class classifier 712 can generate the classification 818 based on the threshold scores. For example, the system can set one or more thresholds, such as the media engagement score being greater than a particular number, and the multi-class classifier 712 can output the classification 818 based on the one or more thresholds. The system can then provide the classification 818 to the engagement resource activator 720.

Based on the classification 818, the engagement resource activator 720 can select and deliver one or more tailored experiences for the user. In particular, if the classification 818 classifies the user as an average user, the engagement resource activator 720 can select a relatively less intense experiences that encourage the user to interact with the subject. For example, the engagement resource activator 720 can deliver soft encouragement to interact with the subject, such as “Your friends are playing this!” or encouragement to engage in special challenges or free trails associated with the subject. If the classification 818 classifies the user as a detracting user, the engagement resource activator 720 can select experiences to decrease the negative engagement. For example, the engagement resource activator 720 can trigger customer support outreach for the detracting user or determine whether the user's interactions require action. If the classification 818 classifies the user as an enthusiast user, the engagement resource activator can select relatively more intense experiences that encourage the user to interact with the subject. For example, the engagement resource activator 720 can deliver invitations to events or access to programs. If the classification 818 classifies the user as an enthusiast user, the engagement resource activator can select relatively more intense experiences than the experiences for an enthusiast user that encourage the user to interact with the subject. For example, the engagement resource activator 720 can deliver invitations to VIP events, access to beta programs, sneak peeks, private social media communities, and/or dynamic user interface customization. For example, if a user is a super-enthusiast user towards a particular movie franchise, the system can provide customized user interfaces associated with the movie franchise.

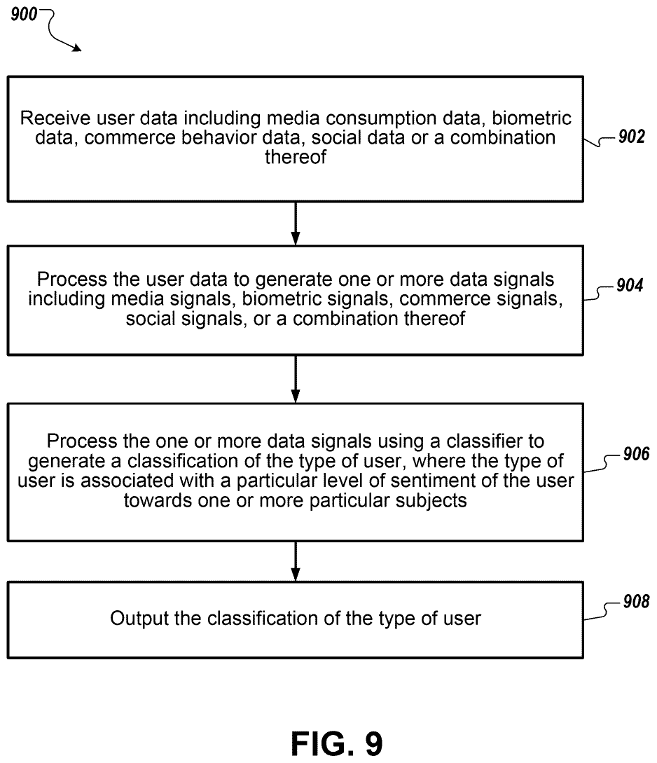

FIG. 9 is a flow diagram of an example process for using user data to generate a classification of a type of user. For convenience, the process 900 will be described as being performed by a system of one or more computers located in one or more locations. For example, an engagement resource activation system, e.g., the engagement resource activation system 700 of FIG. 7, appropriately programmed, can perform the process 900.

The system can receive user data including media consumption data, biometric data, commerce behavior data, social data, or a combination thereof (902). The media consumption data includes a media viewing history of the user, media interaction history of the user, or both. The biometric data includes data associated with a biometric device of the user that measures a heart rate of the user. In some examples, the biometric data includes facial recognition data, voice recognition data, or both. The commerce behavior data includes recent purchase history of the user. The social data includes activity data for the user associated with a social media website.

The system can process the user data to generate one or more data signals including media signals, biometric signals, commerce signals, social signals, or a combination thereof (904).

The system can process the one or more data signals using a classifier to generate a classification of the type of user, where the type of user is associated with a particular level of sentiment of the user towards one or more particular subjects (906). The type of user can be an average user, a detracting user, an enthusiast user, and a super-enthusiast user. The one or more particular subjects can be an entity, an object, an event, a time, a location, or content. In some examples, the classifier is a multi-class classifier neural network. In some examples, the classifier is a rule-based classifier.

In some examples, the system processes the one or more data signals using the classifier by generating, by the classifier, a respective probability value of each type of user by processing the one or more data signals, and the system can classify the type of user based on a threshold value associated with the respective probability of each type of user.

The system can output the classification of the type of user (908).

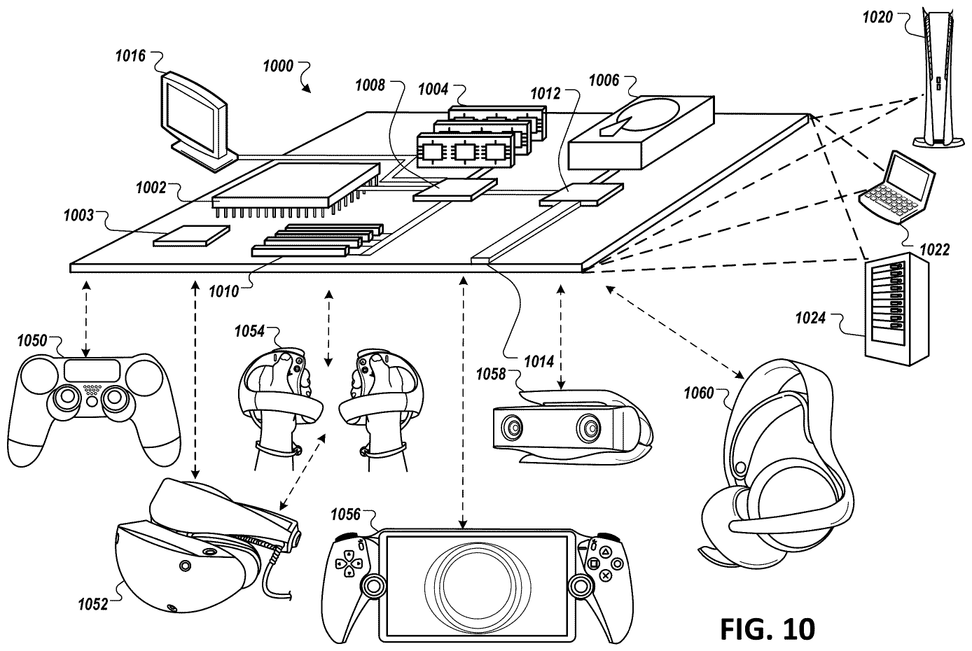

FIG. 10 shows an example of a computing device 1000 and associated accessories that can be employed to execute implementations of the present disclosure.

The computing device 1000 can be a gaming console 1020, such as PS5®, PS4®, PS3®, PS2® etc., or as one or more servers 1024 or as a rack within a server. The one or more servers 1024 can be associated with a premises or a control system. In some implementations, the computing device 1000 may be implemented as a personal computer such as a laptop computer 1022. In some implementations, the computing device 1000 can be implemented as a mobile device such as the connected handheld gaming device 1056. In some implementations, a computing device can include one or more of the computing device 1000, and an entire system may be made up of multiple computing devices communicating with each other. For example, a gaming system can include one or more of a gaming console 1020, one or more accessories, and a remote platform such as a cloud-based platform implemented on one or more servers 1024. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 1000 includes some combination of one or more processors or central processing units (CPUs) 1002, one or more graphic processing units (GPUs) 1003, memory 1004, one or more storage devices 1006, a high-speed interface 1008, and/or a low-speed interface 1012. In some implementations, the high-speed interface 1008 connects to the memory 1004 and multiple high-speed expansion ports 1010. In certain implementations, the low-speed interface 1012 connects to a low-speed expansion port 1014 and the storage device 1004. In some implementations, the high-speed interface 1008 connects to the storage device 1004. Each of the processor 1002, the GPU 1003, the memory 1004, the storage device 1006, the high-speed interface 1008, the high-speed expansion ports 1010, and the low-speed interface 1012, are interconnected using various buses, and may be mounted on a common motherboard or in other manners as appropriate. The processor 1002 can process instructions for execution within the computing device 1000, including instructions stored in the memory 1004 and/or on the storage device 1006 to display graphical information for a graphical user interface (GUI) on an external input/output device, such as a display 1016 coupled to the high-speed interface 1008. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1004 stores information within the computing device 1000. In some implementations, the memory 1004 includes a volatile memory unit or units. Alternatively, or in addition, the memory 1004 can include a non-volatile memory unit or units. The memory 1004 may also include another form of a computer-readable medium, such as a magnetic or optical disk. In some implementations, the memory 1004 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 1006 provides mass storage for the computing device 1000. In some implementations, the storage device 1006 may be or include a computer-readable medium, such as a hard disk device, an optical disk device, a flash memory, or other similar solid-state memory device, or an array of devices, including devices in a storage area network or other configurations. In some implementations, the storage device 1006 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 1006 can be configured to support expandable storage via compatible non-volatile memory express (NVMe) SSDs. Instructions can be stored in an information carrier, and when executed by one or more processing devices, such as processor 1002, perform one or more methods, such as those described above. The instructions can also be stored by one or more storage devices, such as non-transitory computer-readable or machine-readable mediums, such as the memory 1004, the storage device 1006, or memory on the processor 1002. The instructions can constitute software for providing interactive game play on a user interface such as a graphical user interface (GUI) presented on the display 1016.

The high-speed interface 1008 generally manages bandwidth-intensive operations for the computing device 1000, while the low-speed interface 1012 generally manages lower bandwidth-intensive operations. Such allocation of functions is an example only. In some implementations, the high-speed interface 1008 is coupled to the memory 1004, the display 1016 (e.g., through a graphics processor or accelerator), and to the high-speed expansion ports 1010, which accepts various expansion cards. In the implementation, the low-speed interface 1012 is coupled to the storage device 1006 and the low-speed expansion port 1014. The low-speed expansion port 1014, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 1050 such as a DualSense®, DualShock®, or Access™ controllers for PlayStation® devices, a virtual reality (VR) or augmented reality (AR) headset 1052 such as the PS VR2 headset, accessory controllers 1054 such as PS VR2 Sense™, a handheld gaming device 1056 such as PlayStation Portal®, a camera 1058, and/or an earphone/headphone set 1060 such as the PULSE Elite™ headset or the Pulse Explore™ earbuds. In some implementations, the computing device 1000 includes one or more acoustic transducers, and/or is connected to one or more external acoustic transducers such as one or more speakers associated with the display 1016.

The processor 1002 can be implemented as a chipset of chips that include separate and multiple analog and digital processors. For example, the processor 1002 can be a multi-core processor that supports high-speed processing and enables complex computational tasks, real-time physics simulations, and advanced artificial intelligence (AI) capabilities. In one example, the processor 1002 includes at least 8 cores, at least 16 threads, and operates at variable frequencies around 3.5 GHz or more. In some implementations, the processor 1002 may be a Complex Instruction Set Computers (CISC) processor, a Reduced Instruction Set Computer (RISC) processor, or a Minimal Instruction Set Computer (MISC) processor.

In some implementations, the GPU 1003 includes a custom GPU that supports an advanced architecture such as the RDNA 2 architecture developed by AMD. In certain examples, the GPU 1003 includes at least 36 compute units running at speeds of 2 GHz or more, and delivers performance of at least 10 teraflops. The GPU 1003 can be configured to support high quality graphics rendering. For example, the GPU 1003 can be configured to support hardware-accelerated ray tracing for enhanced realism in lighting and reflections, thereby providing a highly immersive gaming experience.

The computing device 1000 can be configured to interact with one or more connected input/output or accessory device in providing the gaming experience. In some implementations, the computing device communicates with a handheld controller 1050—e.g., a DualSense®, DualShock®, or Access™ controller for PlayStation® devices—to provide the gaming experience. The controller 1050 can feature a high-fidelity haptic feedback system with one or more actuators that simulate a wide range of tactile sensations. In some implementations, the controller 1050 includes one or more adaptive triggers that adjust resistance based on in-game actions to provide for a realistic feel.

The ergonomic design of the controller 1050 can allow for comfortable use even in long gaming sessions. For example, the controller 1050 can include textured grips and an optimized button layout. In some implementations, the controller 1050 includes one or more of: integrated motion sensors, a high-resolution touchpad, and a built-in microphone array. The controller 1050 includes an array of buttons, joysticks, and other controls that allow a user to interact with the computing device 1000 to participate in interactive gameplay presented, for example, on a display device such as the display 1016. The controller 1050 can be powered by one or more regular or rechargeable batteries and supports both wireless and wired connectivity with the computing device 1000, for example, via Bluetooth, WiFi, USB-C etc., or via a proprietary connection such as PlayStation Link™. In some implementations, the controller 1050 includes a light bar and player indicators for visual feedback and customization.

In some implementations, the input/output or accessory device includes a VR/AR headset 1052. One example of such a headset is the PlayStation VR2 (PS VR2) headset that is configured to provide an immersive and interactive gaming experience. In some implementations, the headset 1052 features dual displays, e.g., organic light emitting device displays or micro-LED displays, with a combined resolution of 4000 10 2080 pixels or higher—thus providing sharp visuals and a wide field of view.

In some implementations, the VR/AR headset 1052 includes eye-tracking technology that enables foveated rendering, by focusing on where the user is looking. In some implementations, the headset 1052 includes integrated cameras that facilitate tracking head movements without external sensors. In some implementations, the headset includes haptic feedback for tactile sensations and/or one or more acoustic transducers configured to provide a spatial sound effect the user. The headset 1052 can include an adjustable headband and cushioned padding, and can be configured to connect to the computing device 1000 either over a wireless network (e.g., over a WiFi® or Bluetooth® connection, or a proprietary connection such as PlayStation Link™) or over a wire such as a USB-C cable.

In some implementations, the headset 1052 can be configured to work in conjunction with one or more accessory controllers 1054 such as the PlayStation VR2 Sense™ controllers. The accessory controllers 1054 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 1054 can provide a comfortable experience even during extended gameplay. In some implementations, the accessory controllers include one or more integrated sensors (accelerometer, gyroscope, etc.) and/or cameras to provide motion tracking. The accessory controllers 1054 can be configured to connect to the computing device 1000 and/or the headset 1052 over a wireless connection such as WiFi® or Bluetooth®.

In some implementations, the computing device 1000 is connected to a handheld gaming device 1056 such as the PlayStation Portal®. The handheld gaming device 1056 can be configured to stream games and media from the computing device 1000 via a wireless connection such as WiFi® or Bluetooth®. The handheld gaming device 1056 includes a high-resolution screen that allows users to play games and/or stream media remotely without using the display 1016 connected to the computing device 1000. This allows the display to be used for other purposes while the computing device 1000 facilitates gameplay on the handheld gaming device 1056. In some implementations, the handheld gaming device 1056 is configured to act as a streaming receiver without running games natively on the device 1056 itself. This makes the handheld gaming device 1056 a convenient option for playing games run on the computing device 1000, while leaving a TV connected to the computing device 1000 free to be used for viewing other media. The handheld gaming device 1056 can includes buttons and features similar to (or even same as) the controller 1050, thus providing for a similar gaming experience as that with the controller 1050.

In some implementations, the input/output or accessory devices includes a camera 1058 and/or an earphone/headphone set 1060 such as the PULSE Elite™ headset or the Pulse Explore™ earbuds. The camera 1058 can be used to track user-movements, which in turn can be used as an input to an interactive game being executed on the computing device 1000. The earphone/headphone set 1060 can be used to provide audio feedback/output to a user from the computing device 1000. In some implementations, the earphone/headphone set 1060 can include a microphone to receive spoken inputs/instructions that in turn can be used to control an interactive game being executed on the computing device 1000.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for determining a type of user, the method comprising:
receiving user data comprising at least two of media consumption data, biometric data, commerce behavior data, or social data;
processing the user data to generate a plurality of data signals comprising at least two of media signals, biometric signals, commerce signals, or social signals, wherein processing the user data comprises detecting and selecting, from the at least two of media consumption data, biometric data, commerce behavior data, or social data, data points indicating variations or patterns that exceed baseline levels;
processing the plurality of data signals using a classifier to generate a classification of the type of user, wherein the type of user is associated with a particular level of sentiment of the user towards one or more particular subjects; and
outputting the classification of the type of user.

2. The method of claim 1, wherein the one or more particular subjects comprise one or more of an entity, an object, an event, a time, a location, or content.

3. The method of claim 1, wherein the type of user comprises an average user, a detracting user, an enthusiast user, and a super-enthusiast user.

4. The method of claim 1, wherein the media consumption data comprises a media viewing history of the user, media interaction history of the user, or both.

5. The method of claim 1, wherein the biometric data comprises data associated with a biometric device of the user, wherein the biometric device measures a heart rate of the user.

6. The method of claim 5, wherein the biometric data further comprises facial recognition data, voice recognition data, or both.

7. The method of claim 1, wherein the commerce behavior data comprises recent purchase data of the user.

8. The method of claim 1, wherein the social data comprises activity data for the user associated with a social media website.

9. The method of claim 1, wherein the classifier is a multi-class classifier neural network.

10. The method of claim 1, wherein the classifier is a rule-based classifier.

11. The method of claim 1, wherein processing the one or more data signals using the classifier to generate a classification of the type of user comprises:
generating, by the classifier, a respective probability value of each type of user by processing the one or more data signals; and
classifying the type of user based on a threshold value associated with the respective probability of each type of user.

12. A system comprising one or more computers and one or more computer storage devices storing instructions that, when executed by the one or more computers, cause the one or more computers to perform operations for activating rich engagement resources, the operations comprising:
receiving user data comprising at least two of media consumption data, biometric data, commerce behavior data, or social data;
processing the user data to generate a plurality of data signals comprising at least two of media signals, biometric signals, commerce signals, or social signals, wherein processing the user data comprises detecting and selecting, from the at least two of media consumption data, biometric data, commerce behavior data, or social data, data points indicating variations or patterns that exceed baseline levels;
processing the plurality of data signals using a classifier to generate a classification of the type of user, wherein the type of user is associated with a particular level of sentiment of the user towards one or more particular subjects; and
outputting the classification of the type of user.

13. The system of claim 12, wherein the one or more particular subjects comprise one or more of an entity, an object, an event, a time, a location, or content.

14. The system of claim 12, wherein the type of user comprises an average user, a detracting user, an enthusiast user, and a super-enthusiast user.

15. The system of claim 12, wherein the media consumption data comprises a media viewing history of the user, media interaction history of the user, or both.

16. The system of claim 12, wherein the biometric data comprises data associated with a biometric device of the user, wherein the biometric device measures a heart rate of the user.

17. One or more non-transitory computer readable storage media storing instructions that, when executed by one or more computers, cause the one or more computers to perform operations for activating rich engagement resources, the operations comprising:
receiving user data comprising at least two of media consumption data, biometric data, commerce behavior data, or social data;
processing the user data to generate a plurality of data signals comprising at least two of media signals, biometric signals, commerce signals, or social signals, wherein processing the user data comprises detecting and selecting, from the at least two of media consumption data, biometric data, commerce behavior data, or social data, data points indicating variations or patterns that exceed baseline levels;
processing the plurality of data signals using a classifier to generate a classification of the type of user, wherein the type of user is associated with a particular level of sentiment of the user towards one or more particular subjects; and
outputting the classification of the type of user.

18. The one or more non-transitory computer readable storage media of claim 17, wherein the one or more particular subjects comprise one or more of an entity, an object, an event, a time, a location, or content.

19. The one or more non-transitory computer readable storage media of claim 17, wherein the type of user comprises an average user, a detracting user, an enthusiast user, and a super-enthusiast user.

20. The one or more non-transitory computer readable storage media of claim 17, wherein the media consumption data comprises a media viewing history of the user, media interaction history of the user, or both.
